(19) United States
(12) Patent Application Publication
(10) Pub. No.: US 2015/0266275 A1
(43) Pub. Date: Sep. 24, 2015

(54) INTERCEPTION DEVICE MADE FROM THERMOPLASTIC POLYURETHANE

(71) Applicant: BASF SE, Ludwigshafen (DE)

(72) Inventors: Dietrich Scherzer, Neustadt (DE); Guenter Scholz, Brownstown Twp, MI (US); Eckehard Moritz, Muenchen (DE)

(73) Assignee: BASF SE, Ludwigshafen (DE)

(21) Appl. No.: 14/434,999

(22) PCT Filed: Oct. 10, 2013
(86) PCT No.: PCT/EP2013/071203

§ 371 Date: Apr. 10, 2015

(30) Foreign Application Priority Data
Oct. 10, 2012 (EP) 12187967.0

(51) Int. Cl. B32B 27/06; A63B 71/02; B32B 3/26; C08K 3/00; B32B 27/40

(52) U.S. Cl. CPC B32B 27/06; C08K 3/0041; B32B 27/40; B32B 3/266; A63B 71/022; B32B 2250/03; B32B 2307/412; B32B 2459/00

(57) ABSTRACT

The invention relates to an interception device for moving articles or persons based on thermoplastic polyurethane which is obtained via the reaction in each case of at least one of the following starting materials: (a) diisocyanate, (b) compound which is reactive toward isocyanate and which has a number-average molar mass (M_{w}) of from 0.500×10³ g/mol to 10×10³ g/mol, (c) chain extender which has a molar mass of from 50 g/mol to 499 g/mol, and also optionally (d) with use of catalyst, of conventional auxiliaries and/or (f) of additives, where the interception device comprises a foil or a network made of the thermoplastic polyurethane and retention devices between which the foil or the network has been stretched flat, and the thermoplastic polyurethane is transparent. The invention further relates to the use of thermoplastic urethane for producing interception devices, and to a production process for an interception device made of thermoplastic polyurethane.

The invention relates to an interception device based on thermoplastic polyurethane.

Networks made of polymers for, by way of example, football pitches or tennis courts have been known for a long time: DE 3037928 A1 describes a network with cutouts based on synthetic materials, these being fixed via heat treatment and in particular used as football nets and tennis nets.

DE 203 00 540 also describes a net for protecting entrances to garages during ball games.

A feature common to the networks known from the prior art is that their design is primarily intended to intercept balls, where these have a large surface area and therefore where the point load acting on the network is relatively small. Another disadvantage is that these networks are composed of colored materials, and this by way of example impairs observation and/or filming through these networks, for example in the case of a football net or nets used as barriers during ski races.

Nets known hitherto, based on commercially available polymers, are therefore completely unsuitable for use for high-density masses moving at very high speed, for example those conventional in discus throwing or in shot-put.

In particular for these types of sports there has hitherto been no alternative to metal fencing, which is mostly very unattractive and isolates the sportsperson, and is problematic for photographing and filming. Interception devices used in other sectors are also often at least to some extent nontransparent, and this by way of example isolates a sportsperson from onlookers or photographers.

It was therefore the object of the present invention to design interception devices which firstly have very high mechanical stabilities, in particular good tear-propagation resistance, low notch depth, and high impact resistance, so that they are also suitable for masses moving at very high speed, inclusive of small high-density masses. A further intention was that the interception devices be flexible over a very wide temperature range, so that by way of example they can be used for summer sports and winter sports.

Surprisingly, this object was achieved via an interception device for moving persons and/or articles based on thermoplastic polyurethane, preferably based on transparent thermoplastic polyurethane. The thermoplastic polyurethane is obtained via the reaction in each case of at least one of the following starting materials:
(a) isocyanate
(b) compound which is reactive toward isocyanate and which has a number-average molar mass (Mₙ) of from 500 g/mol to 10×10³ g/mol
(c) chain extender which has a molar mass of from 50 g/mol to 499 g/mol,

and also optionally:
(d) catalyst
(e) auxiliary, and/or
(f) additive.

It is preferable that the thermoplastic polyurethane used in the interception device is transparent. It is further preferable that the index T for the transparency of the thermoplastic polyurethane, for a layer thickness h of 8.2 mm, is less than or equal to 3.2. The index for transparency is determined in accordance with DIN 55988 according to the publication dated 1 Apr. 1989, the index 1 here being determined without correction.

In one embodiment, the interception device of the invention is a foil, optionally with a proportion of network, or with a network, as described in more detail hereinafter. These foils or networks are placed in the desired position by using retention devices, e.g. bars and/or tensioning devices, with the aim of intercepting moving parts, preferably articles or persons. In this preferred embodiment the interception device comprises a foil or a network made of the thermoplastic polyurethane, which is preferably transparent, as described in detail at a later stage below, and retention devices. It is preferable that the foil or the network has been stretched flat between the retention devices. It is preferable that the moving articles or persons involve sportspersons and/or sports equipment. The interception devices are in particular, interception fencing of safety fencing which delimits a sports area from the onlooker space, or is intended to prevent sports persons and/or sports equipment from moving beyond a preferred area of activity. Preferred sports equipment for which the interception devices are used are projectiles, balls, or discuses. It is preferable to use the interception devices for airgun pellets, small-caliber bullets, arrows, knives, and javelins. It is also preferable to use the interception devices for small fast-traveling balls and ball-like objects, particularly golf balls, table-football balls, cricket balls, hockey balls, the shots used in shot put, the hammers used in hammer throw, or the stones used in stone-throwing competitions. The interception devices are also preferably used for fast-traveling disks, for example discuses, ice hockey pucks, or table pucks.

The interception device is preferably a network, composed of fillets and holes. In another embodiment, the interception device is a foil. In another preferred embodiment, an interception device comprises at least one area in which it is a foil and one other area in which the interception device is a network, as described in more detail hereinafter.

The production of foils is described by way of example in Polyurethan Handbook, ed. by Günter Oertel, 2nd edn. from the Carl Hanser Verlag, Munich, 1994. Foils are preferably produced via calendering, in which suitable TPU pellets are melted in a first step, optionally mixed with further auxiliaries and/or additives, and by way of example processed by way of rolls to give foils.

In another preferred embodiment, the interception device is a network composed of cutouts and of fillets. The proportion of cutouts in the network is preferably from 1% to 99%, more preferably from 10% to 98%, more preferably from 25% to 97%, and particularly preferably from 50% to 95%.

The proportion of the cutout is determined here by the following method: the interception device is spread out in a plane, a plurality of a repeating underlying unit, preferably 10×10 of these units that form the structure of the network, are illuminated at an angle of 90° with respect to said plane with parallel light, and the extent of shadow constitutes the proportion of the fillets, which together with the cutouts gives a total of 100%.

The production of networks is known. On the one hand, networks are woven by starting from individual filaments, giving threads which in turn are then linked or woven to give networks. The strings woven from individual filaments have the advantage, in respect of mechanical properties, of being very flexible and of having the ability to intercept a particularly large amount of energy, depending on the structure of the weave. Thermoplastic polyurethane is suitable not only for this traditional production process but also in particular for producing networks by using strings in an adhesive bonding process which can either use suitable adhesives, in particular those based on polyurethanes, or can use energy input, preferably only at the linkage points. Another term for this being welding. The energy input is preferably selected in such a way that the thermoplastic polyurethane is heated approximately to the melting point. The energy input is preferably achieved via radiation, e.g. infrared radiation, via microwave, via laser or via thermal heating. However, if the device is suitable, it can also be achieved simply via the rapid increase of pressure between two mutually superposed strings or filaments.

Any other energy input which brings about melting or incipient melting of the thermoplastic polyurethane is equally suitable. The energy input is adjusted in such a way as to avoid dividing the strings but at the same time to soften the thermoplastic polyurethane in such a way that once two strings based on thermoplastic polyurethane have been cooled they are bonded securely to one another and give a durable network structure that can withstand mechanical load. This has the advantage that a first step of network production merely provides individual strings, which in a second step are bonded, preferably thermally bonded, in any desired form of network.

In one embodiment, the network structure is obtained either via laying of filaments or strings with a relatively high or relatively low degree of ordering, and then carrying out welding or adhesive bonding. In another embodiment, the filaments or strings are arranged in such a way as to give a repeating underlying geometric form, which is preferably rectangular or trapezoidal.

In one embodiment, the strings are produced directly via extrusion and are not composed of a plurality of filaments. In one preferred embodiment, the cross section of the strings is flattened in one direction. It is further preferable that the string is a tape. Said tapes are preferably produced by cutting a foil into strips. An advantage of this process is simplified and/or lower-cost production, but in particular the higher transparency of the strings produced from a foil. Another term used here for the filaments, strings, or strips used to produce the network is “fillet” of the network.

In one preferred alternate embodiment, the interception device is a transparent foil based on thermoplastic polyurethane, preferably on transparent thermoplastic polyurethane, as described in detail in this specification. A foil is particularly easy to produce, has very high transparency, and has maximum resistance to penetration by small articles.

Preference further is given to an interception device in which cutouts are removed from a foil, thus giving a net. In principle, cutouts can be cut out before production of the foil for the interception device has been completed. However, it is preferable that the cutouts are removed from a planar foil only after it has been produced. This method gives the residual foil, which preferably has a network structure, particularly good transparency.

It is preferable that there is uniform repetition of the cutouts across the foil or across the network produced therefrom. They can be introduced into the foil via punching, cutting, removal by melting, or any of the other suitable methods for the subsequent production of cutouts. The term cutting means not only cutting with mechanical devices but also cutting with lasers or a water jet.

In one preferred embodiment, the manner in which a plurality of cutouts have been formed and/or have been arranged with respect to one another is such that viewing from a distance gives a pattern, image, character, or the like.

In another preferred embodiment, the foil from which the interception device is produced has been printed with image elements and/or text elements. The possibility of printing the foil or the network is an additional advantage possessed in particular by an interception device produced from a foil.

The printing can on the one hand be carried out on a traditional thermoplastic polyurethane foil, but in one preferred embodiment it is also carried out on the transparent thermoplastic polyurethane. This method permits utilization of the transparency of the foil, in order by way of example to observe a sportsperson, but at the same time it is also possible by way of example to apply advertising. A particularly suitable process for combining transparency of the interception device and printing is screen printing, since this method retains transparency over a large area.

In one preferred embodiment, the network or the foil of the interception device has been produced exclusively from thermoplastic polyurethane. The network or the foil of the interception device is not therefore a laminate with other polymers.

In other preferred embodiments, materials that further improve the toughness have been provided to the thermoplastic polyurethane. In one preferred embodiment this material has a network structure which only slightly impairs the transparency of the thermoplastic polyurethane. The network structure is appropriate for the size of the objects and/or persons to be intercepted. In one preferred embodiment the material of this network structure, reinforcing the thermoplastic polyurethane, is made of metal. It is preferable that the thermoplastic polyurethane entirely surrounds the metal.

The thermoplastic polyurethane used for the interception device is obtained via the reaction in each case of at least one of the following starting materials: organic isocyanate (a), compounds (b) reactive toward isocyanate, chain extender (c), and also, optionally, a catalyst (d), conventional auxiliary (e) and/or additive (f).

The starting components and processes for producing the polyurethanes will be described by way of example below.

Organic isocyanates (a) used can comprise well-known aliphatic, cycloaliphatic, araliphatic and/or aromatic isocyanates, for example tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), meta-tetramethylxylylene diisocyanate (TMXDI), 1,4- and/or 1,3-bis(isocyanatomethyl)cyclohexane, 1,4-cyclohexane diisocyanate, 1-methylcyclohexane 2,4- and/or 2,6-diisocyanate and/or dicyclohexylmethane 4,4′-, 2,4′- and 2,2′-diisocyanate (H12MDI), diphenylmethane 2,2′-, 2,4′- and/or 4,4′-diisocyanate (MDI), naphthylene 1,5-diisocyanate (NDI), tolylene 2,4- and/or 2,6-diisocyanate (TDI), 3,3′-dimethyldiphenyl diisocyanate, 1,2-diphenylethane diisocyanate, hexamethylene 1,6-diisocyanate (HDI) and/or phenylene diisocyanate.

Preference is given to use of aliphatic diisocyanates, and further preference is given to those mentioned above, particular preference being given to hexamethylene 1,6-diisocyanate (HDI), and/or dicyclohexylmethane 4,4′-diisocyanate (H12MDI), the latter preferably being in a mixture with dicyclohexylmethane 2,4′- and 2,2′-diisocyanate.

Compounds (b) that can be used and that are reactive toward isocyanates are the well-known compounds reactive toward isocyanates, for example polyesterols, polyetherols and/or polycarbonatediols, another collective term usually used for these being “polyols”, with number-average molar masses of from 500 g/mol to 10×10³ g/mol, preferably from 0.5×10³ g/mol to 2×10³ g/mol, in particular from 0.8×10³ g/mol to 1.5×10³ g/mol, and preferably with an average functionality with respect to isocyanates of from 1.8 to 2.3, preferably from 1.9 to 2.2, in particular 2. The functionality gives the number, per molecule, of groups reactive toward isocyanate. It is preferable to use polyether polyols, for example those based on well-known starter substances and on conventional alkylene oxides, such as ethylene oxide, propylene oxide and/or butylene oxide, preferably polyetherols based on propylene 1,2-oxide and ethylene oxide and in particular polyoxytetramethylene glycols (PTHF). The polyetherols have the advantage of greater hydrolysis resistance than polyesterols. It is also possible to use, as polyetherols, the compounds known as low-unsaturation-level polyetherols. For the purposes of this invention, low-unsaturation-level polyols are in particular polyether alcohols with less than 0.2 meq/g, preferably less than 0.01 meq/g, content of unsaturated compounds. Polyether alcohols of this type are mostly produced via an addition reaction of alkylene oxides, in particular ethylene oxide, propylene oxide and mixtures thereof, onto the above-described diols or triols in the presence of high-activity catalysts. High-activity catalysts of this type are by way of example cesium hydroxide and multimetal cyanide catalysts, also termed DMC catalysts. A DMC catalyst often used is zinc hexacyanocobaltate. The DMC catalyst can be left in the polyether alcohol after the reaction, but is usually removed, for example, via sedimentation or filtration. It is also possible to use mixtures of various polyols, instead of a single polyol.

It is particularly preferable that the thermoplastic polyurethane is based on polytetramethylene glycol (PTHF) as compound (b) reactive toward isocyanate, particularly preferably with a number-average molar mass of from 0.8×10³ g/mol to 1.5×10³ g/mol.

It is particularly preferable that the structural components a) to c) involve difunctional compounds, i.e. diisocyanates (a), difunctional polyols (b), preferably polyetherols and difunctional chain extenders (c), preferably diols.

Chain extenders (c) used can comprise well-known aliphatic, araliphatic, aromatic and/or cycloaliphatic compounds with a molar mass of from 50 g/mol to 499 g/mol, preferably having 2 groups reactive to isocyanate, preference being given to alkanediols having from 2 to 10 carbon atoms in the alkyl moiety, in particular 1,3-propanediol, 1,4-butanediol, 1,6-hexanediol and/or di-, tri-, tetra-, penta-, hexa-, hepta-, octa-, nona- and/or decaalkylene glycols, preference being given to butanediol and/or propanediol, and this means that butanediol or propanediol are used as individual substance or in a mixture comprising at least these two chain extenders.

In one preferred embodiment, main chain extender (c1) used preferably comprises a straight-chain or branched alkanediol having from 2 to 6 carbon atoms, and co-chain extender (c2) used preferably comprises one or more straight-chain or branched alkanediols having 2 to 12 carbon atoms, where main chain extender (c1) and co-chain extender (c2) differ in the number of carbon atoms and/or are structural isomers. It is particularly preferable that the main chain extender (c1) is 1,4-butanediol, where this is reacted with the at least one co-chain extender (c2) and with the isocyanate (a), which is preferably hexamethylene 1,6-diisocyanate (HDI), and/or dicyclohexylmethane 4,4′-diisocyanate (H12MDI), and also with one of the abovementioned polyols which is preferably PTHF.

It is particularly preferable that the co-chain extender (c2) is 1,3-propanediol and/or 1,6-hexanediol, especially 1,3-propanediol.

The ratio of the amount of substance n1 of the main chain extender (c1) to the total amount of substance (n) of all of the chain extenders used is calculated as n1/n and is preferably from 0.80 to 0.999.

The amount of substance of a chain extender is the weight of the chain extender used and by way of example is stated in [g] or other suitable units of weight. The total amount of substance (n) of all of the chain extenders used is thus calculated from the sum of the individual weights of all of the chain extenders used.

It is further preferable that the thermoplastic polyurethane used for producing the interception device has a hard-phase content of more than 0.40, particularly preferably more than 0.5, where the hard-phase content is defined by the following formula:

$$Hard \text{-} phase content = \{ {\sum }_{x = 1}^{k} \{ [ ( {m}_{CEx} / {M}_{CEx} ) * {M}_{iso} {m}_{CEx} ] \} / {m}_{tot}$$

where the definitions are as follows:
   MCEₓ: molar mass of the chain extenders x in g/mol
   mCEₓ: mass of the chain extender x in g
   Mᵢₛₒ: molar mass of the isocyanate used in g/mol
   mₜₒₜ: total mass of all of the starting materials in g
   k: number of chain extenders.

The term structural component is used for each of the following: diisocyanates (a), compounds (b) reactive toward isocyanates (b), and chain extenders (c), and the term structural components is used for these collectively.

The invention further provides the use of the thermoplastic polyurethane described above for producing interception devices, in particular the interception devices described above, more preferably for the uses cited.

Particular preference is further given to an interception device produced from thermoplastic polyurethane with a Charpy notched impact resistance at −30° C. of more than 10 kJ/m², preferably more than 15 kJ/m² in accordance with DIN EN ISO 179-1/1eA.

Catalysts (d) added are preferably those which in particular accelerate the reaction between the NCO groups of the isocyanates (a) and the hydroxy groups of the polyols of structural components (b) and (c). The catalysts (d) can be added individually or else in a mixture with one another. It is preferable that the catalysts are organometallic compounds, such as tin(II) salts of organic carboxylic acids, preferably tin(II) dioctanoate, tin(II) dilaurate, dibutyltin diacetate and dibutyltin dilaurate, or bismuth salts. The oxidation state of the bismuth in the bismuth salt is preferably 2 or 3, in particular 3. Preferred carboxylic acids used are those having from 6 to 14 carbon atoms, particularly having from 8 to 12 carbon atoms. Examples of preferred bismuth salts are bismuth(III) neodecanoate, bismuth 2-ethylhexanoate and bismuth octanoate. Other preferred catalysts are tertiary amines such as tetramethylethylenediamine, N-methylmorpholine, diethylbenzylamine, triethylamine, dimethylcyclohexylamine, diazabicyclooctane, N,N′-dimethylpiperazine, N-methyl-N′-(4-N-dimethylamino)butylpiperazine, N,N,N′,N″,N″-pentamethyldiethylenediamine, or the like. Other catalysts that can be used are: amidines, e.g. 2,3-dimethyl-3,4,5,6-tetrahydropyrimidine, tris(dialkylaminoalkyl)-s-hexahydrotriazines, in particular tris(N,N-dimethylaminopropyl)-s-hexahydrotriazine, tetraalkylammonium hydroxides, e.g. tetramethylammonium hydroxide, alkali metal hydroxides, e.g. sodium hydroxide, and alkali metal alcoholates, e.g. sodium methoxide and potassium isopropoxide, and also alkali metal salts of long chain fatty acids having from 10 to 20 carbon atoms, and optionally having pendant OH groups. The amounts used of the catalysts (d) depend on the reactivity required and are from 0.001% by weight to 0.5% by weight, based on the total weight of the thermoplastic polyurethane.

Other substances that can be added, alongside catalysts (d), to structural components (a) to (c) are conventional auxiliaries (e) and/or additives (f). Mention may be made by way of example of surfactant substances, nucleating agents, lubricants and mold-release aids, dyes, pigments, antioxidants, e.g. in relation to hydrolysis, light, heat or discoloration, inorganic and/or organic fillers, flame retardants, reinforcing agents, plasticizers, and metal deactivators. In one preferred embodiment the definition of component (e) also covers hydrolysis stabilizers, such as polymeric and low-molecular-weight carbodiimides. It is preferable that the thermoplastic polyurethane comprises triazole, and/or triazole derivative, and antioxidants in an amount of from 0.1% by weight to 5% by weight, based on the total weight of the thermoplastic polyurethane. Suitable antioxidants are generally substances which inhibit or prevent undesired oxidative processes within the polyurethane requiring protection. Antioxidants are generally available commercially. Examples of antioxidants are sterically hindered phenols, aromatic amines, thiosynergists and for light stabilizers, organophosphorus compounds of trivalent phosphorus, and hindered amine light stabilizers. Examples of sterically hindered phenols are found in Plastics Additives Handbook, 5^{th} edition, H. Zweifel, ed., Hanser Publishers, Munich, 2001 ([1]), pp. 98-107 and pp. 116-121. Examples of aromatic amines are found in [1], pp. 107-108. Examples of thiosynergists are found in [1], pp. 104-105 and pp. 112-113. Examples of phosphites are found in [1], pp. 109-112. Examples of hindered amine light stabilizer are found in [1], pp. 123-136.

In one preferred embodiment, the molar mass of the antioxidants, in particular the phenolic antioxidants, is greater than 0.35×10³ g/mol, particularly greater than 0.7×10³ g/mol and at the same time their maximum molar mass is less than 10×10³ g/mol, preferably less than 3×10³ g/mol. The melting point of the antioxidants is moreover preferably below 180° C. It is moreover preferable to use antioxidants which are amorphous or liquid. It is equally possible to use mixtures of two or more antioxidants.

Suitable light stabilizers and combinations thereof can also be found in WO 2003/031506 A1 and in the corresponding references, e.g. Polyurethane Handbook, 2nd edition by Günter Oertel, Hanser Verlag, Munich.

It is preferable that alongside components a), b) and c) mentioned, and optionally d), e) and f), chain regulators are also used, preferably with a number-average molar mass of from 0.031×10³ g/mol to 3×10³ g/mol. These chain regulators are compounds which have only one functional group reactive toward isocyanates, examples being monofunctional alcohols, monofunctional amines and/or monofunctional polyols. These chain regulators can be used to adjust flow behavior of the thermoplastic polyurethanes as desired. The amounts that can be used of chain regulators are generally from 0 parts by weight to 5 parts by weight, preferably 0.1 part by weight to 1 part by weight, based on 100 parts by weight of component b), i.e. of the polyol, and they are defined, i.e. for any calculations of quantitative proportions, as being part of component (c), i.e. of the chain extenders.

The molar ratios of structural components (b) polyol and (c) chain extender can be varied relatively widely in order to adjust the hardness of the TPUs. Molar ratios of component (b) to the entire amount of chain extenders (c) to be used that have proven successful are from 10:1 to 1:10, in particular from 1:1 to 1:4, where the hardness of the TPUs rises as content of chain extender (c) increases.

It is preferable to use a thermoplastic polyurethane which has a hardness of from 60 Shore A to 60 Shore D, where the hardness is preferably from 70 Shore A to 55 Shore D, and is very particularly preferably from 90 Shore A to 95 Shore A, where the Shore hardness is preferably determined in accordance with DIN 53505.

The reaction of structural components described above can take place with conventional indices. The index is defined via the ratio of the total amount of isocyanate groups used during the reaction in component (a) to the amount of groups reactive toward isocyanates, i.e. to the active hydrogen atoms, in components (b) and (c), i.e. in the polyols and chain extenders. If the index is 1000, there is one active hydrogen atom, i.e. one function reactive toward isocyanates, in components (b) and (c), for each isocyanate group in component (a). For indices above 1000, there are more isocyanate groups than OH groups present. It is preferable that the thermoplastic polyurethanes are produced with an index of from 950 to 1050, particularly preferably with an index of from 970 to 1010, in particular from 980 to 995.

Preferred embodiments comprise, as additives (f) organic and inorganic powders or fibrous substances, or else a mixture thereof. It is preferable that these additives take the form of fibers. Examples of organic additives are wood, flax, hemp, ramie, jute, leather, sisal, cotton, cellulose, and aramid fibers. Examples of inorganic additives are silicates, baryte, glass fibers, zeolites, glass, carbon fibers, metals, metal oxides, and pulverulent inorganic substances, such as talc, chalk, kaolin (Al₂(Si₂O₅)(OH)₄), aluminum hydroxide, magnesium hydroxide, aluminum nitrite, aluminum silicate, barium sulfate, calcium carbonate, calcium sulfate, silica, powdered quartz, Aerosil, alumina, mica and wollastonite.

Preferred embodiments comprise fibrous additives with fiber length from 0.1 μm to 100 μm, more preferably in the range from 1 μm to 50 μm. It is preferable that the filler contents are from 5% by weight to 80% by weight.

Processes for producing polyurethanes, also termed TPUs in this specification, are well known. TPUs are generally produced via reaction of in each case at least one (a) isocyanate with (b) one compound reactive toward isocyanate, and (c) chain extender, optionally in the presence of (d) a catalyst and/or (e) an auxiliary and/or (f) an additive, where the individual components and the resultant polyurethane have the specification described above.

The TPUs can be produced by the known processes continuously, for example by using reactive extruders or the belt process, in the one-shot process or batchwise in the known prepolymer process. In these processes, components (a), (b), and optionally (c), (d), (e) and/or (f), to be reacted can be mixed with one another in succession or simultaneously, whereupon reaction immediately begins. These processes are also described in U.S. Pat. No. 3,233,025 or EP 1 846 465 B1. In the extruder process, structural components (a), (b), and also optionally (c), (d), (e) and/or (f), are introduced individually in the form of a mixture into the extruder, preferably at temperatures of from 100 to 280° C., and preferably reacted at from 140 to 250° C., and the resultant TPU is extruded, cooled, and pelletized.

These pellets are preferably processed via extrusion to give the foils, filaments, or strings needed for the interception device.

In an alternate process, prepolymers are first produced, i.e. adducts made from diisocyanate and polyol, and optionally chain extender, where the number-average molecular weight of these is markedly below that of the fully reacted polyol. These products often have better processability and/or better shelf life.

In the belt process, the individual components for producing the thermoplastic polyurethanes are metered into a mixing head and the liquid mixture runs directly on to a circulating belt located thereunder, on which the mixture reacts to completion with use of a fixedly adjusted temperature profile. The hardened polymer located on the belt is also termed a skin. In accordance with EP 0 922 552 B1, the material reacted to give the polymer can be directly at the end of the belt into an extruder for the forming process to give pellets. As an alternative, the skin is granulated in a first step, reheated and mixed in a separate extruder, and re-pelletized. The forming process carried out on the material of the skin is advantageous for homogenizing the resultant material. The procedure can be repeated more than once in order to optimize homogeneity.

Temperatures prevailing during the reaction and/or during the incorporation of the additives and/or auxiliaries are preferably from 100° C. to 280° C., with preference from 140° C. to 250° C. The resultant thermoplastic polyurethane is cooled and granulated and thus used for the further production of the filaments, strings, or strips used for the interception equipment. The filaments, strings or strips are produced in commercially available extruders. Commercially available flat- or blown-film plants are also used with preference for producing strips or foils, and calenders are also used with preference in particular for foil production.

If requirements placed upon strength are relatively stringent, it is preferable that reinforcing fibers are introduced directly in compounding extruders. As an alternative, directly after melt processing, the hot melt emerging from an extrusion die is immediately applied or pressed on to a woven fabric or networks running co-currently. In an equally preferred alternate embodiment, finished foils or small strips are applied onto a woven fabric made of plastic or metal. The latter is achieved by way of thermal and/or pressing processes.

### EXAMPLES

### Example 1

A mixture of the polyol, the chain extender, and optionally the hydrolysis stabilizer, antioxidant, and/or light stabilizer, with a feed temperature of 150° C., on the one hand, and also separately therefrom the isocyanate, with a feed temperature of 65° C., are metered into the first barrel section of a ZSK 92 twin-screw extruder from Werner & Pfleiderer, Stuttgart with a screw length of 48 D and a radial gap of 0.6 mm between screw and barrel. The rotation rate of the twin-screw system was 280 min⁻¹. The temperature settings for the barrel sections were, in the downstream direction, 200° C. in the first third of the screw, 170° C. in the second third of the screw, and 190° C. in the third and last third of the screw. Output was 850 kg/h.

After the melt has been chopped by underwater pelletization, and integrated centrifugal drying, the pellets were finally dried at about 80 to 90° C. and then molded by way of a calender to give a foil of thickness 1.5 mm from which an interception device in the form of a network was punched out by a punching tool.

In the examples that follow, the starting materials for producing the pellets of example 1 are listed, these being used in a second step for calendering of foils for producing interception nets. These examples give examples of formulations. They cover a wide range of Shore hardness, with and without light stabilizer, and can be altered in the invention to cover a variety of conventional polyester variants and polyether variants, without loss of suitability as interception net.

### Example 2

| | |
|---|---|
| Dicyclohexylethane diisocyanate (H12MDI) | 31% |
| Polytetrahydrofuran (PTHF) | 62% |
| 1,4-Butanediol | 5.6% |
| Irganox*) 1010 | 1% |
| Tinuvin **)622 | 0.2% |
| Tinuvin 312 | 0.3% |

*)sterically hindered phenolic antioxidant from BASF SE
**) light stabilizer, sterically hindered amine from BASF SE

The Shore hardness of the material is about 80 A.

Comparable results were achieved when 1,4-butanediol was replaced with 1,3-propanediol in the formulation or a mixture of 1,4-butanediol and 1,3-propanediol was used.

### Example 3

| | |
|---|---|
| Hexamethylene 1,6-diisocyanate (HDI) | 52.3% |
| Polytetrahydrofuran (PTHF) | 31.4% |
| 1,4-Butanediol | 15.8% |
| Irganox 1010 *) | 0.25% |
| Octanol | 0.25% |

*) sterically hindered phenolic antioxidant from BASF SE

The Shore hardness of the material is about 75 D.

### Example 4

| | |
|---|---|
| Hexamethylene 1,6-diisocyanate (HDI) | 37.6% |
| Butanediol adipate 2500 | 49.5% |
| 1,4-Butanediol | 11.5% |
| Stabaxol P 200 ***) | 0.4% |
| Octanol | 0.5% |
| Irganox 1010 *) | 0.2% |
| Tinuvin 622 **) | 0.25% |
| Tinuvin 213 | 0.15% |

*) sterically hindered phenolic antioxidant from BASF SE
**) light stabilizer, sterically hindered amine from BASF SE
***) hydrolysis stabilizer for thermoplastic polyester polyurethanes from Rhein Chemie

The Shore hardness of the material is about 95 A.

### Example 5

The layer thickness h of the thermoplastic polyurethane of examples 1 to 4 is 8.2 mm, and an index T for transparency is less than or equal to 3.2. The index for transparency is determined in accordance with DIN 55988 according to the publication dated Apr. 1, 1989, the index 1 here being determined without correction.

1. An interception device adapted for intercepting articles or persons, which interception device comprises at least one of a foil and a network comprising a transparent thermoplastic polyurethane and a retention device between which the foil and/or the network has been stretched flat, wherein the thermoplastic polyurethane is obtained by reaction of the following starting materials:
(a) an isocyanate
(b) a compound which is reactive toward isocyanate and which has a number-average molar mass (Mₙ) of from 500 g/mol to 10×10³ g/mol, and
(c) a chain extender which has a molar mass of from 50 g/mol to 499 g/mol,
and optionally with:
(d) a catalyst
(e) an auxiliary, and/or
(f) an additive.

2. The interception device according to claim 1, wherein the thermoplastic polyurethane has an index T for the transparency thereof, for a layer thickness h of 8.2 mm, of less than or equal to 3.2, determined in accordance with DIN 55988, the index 1 here being determined without correction.

3. The interception device according to claim 1,
wherein the network comprises fillets and cutouts.

4. The interception device according to claim 3, wherein the cutouts of the network have been produced via removal of portions of foil.

5. The interception device according to claim 1, which comprises a network, comprising fillets connected to give a network structure, wherein the fillets have been connected via adhesive bonding or via welding.

6. The interception device according to claim 5, wherein the fillets are foil webs.

7. The interception device according to claim 1, which has been printed with image elements and/or with text elements.

8. The interception device according to claim 7, wherein the print comprises screen print.

9. The interception device according to claim 1, wherein the isocyanate is aliphatic.

10. The interception device according to claim 1, wherein the compound reactive toward isocyanate is a polyether.

11. The interception device according to claim 10, wherein the polyether is polytetrahydrofuran.

12. The interception device according to claim 1, wherein the chain extender is butanediol, propanediol or a mixture of propanediol and butanediol.

13. The interception device according to claim 1, wherein the thermoplastic polyurethane has a hard-phase content of more than 0.40, where this hard-phase content is calculated via the following formula:
$$Hard \text{-} phase content = \{ {\sum }_{x = 1}^{k} \{ [ ( {m}_{CEx} / {M}_{CEx} ) * {M}_{iso} {m}_{CEx} ] \} / {m}_{tot}$$
where the definitions are as follows:
MCEₓ: molar mass of the chain extenders x in g/mol
mCEₓ: mass of the chain extender x in g
Mᵢₛₒ: molar mass of the isocyanate used in g/mol
mₜₒₜ: total mass of all of the starting materials in g
k: number of chain extenders.

14. The interception device according to claim 1, wherein the chain extender is a mixture of a molar proportion n1 of a main chain extender (c1), based on the total amount of substance n of the chain extenders, and of a molar proportion n2 of at least one further ancillary chain extender c2, based on the total amount of substance n of the chain extenders, and optionally of a molar proportion nx of further ancillary chain extenders cx, wherein the ratio of the molar proportion n1 of the main chain extender (c1) to the sum of the molar proportions of the ancillary chain extenders is from 0.80 to 0.999.

15. (canceled)

16. A process for producing an interception device according to claim 1, which comprises processing in each case at least
(a) an isocyanate
(b) a compound which is reactive toward isocyanate and which has a number-average molar mass (Mₙ) of from 500 g/mol to 10×10³ g/mol
(c) a chain extender which has a molar mass of from 50 g/mol to 499 g/mol,
and optionally:
(d) a catalyst
(e) an auxiliary, and/or
(f) an additive
to give a thermoplastic polyurethane, and producing an interception device therefrom.

17. The interception device according to claim 9, wherein the isocyanate comprises a diisocyanate.

18. The interception device according to claim 17, wherein the diisocyanate comprises hexamethylene 1,6-diisocyanate or 4,4′-diisocyanatodicyclohexylmethane or a mixture thereof.

19. The interception device according to claim 10, wherein the polyether has a number-average molar mass of from 0.5×10³ g/mol to 2×10³ g/mol.
